(19) United States
(12) Patent Application Publication
(10) Pub. No.: US 2009/0174837 A1
(43) Pub. Date: Jul. 9, 2009

(54) Structure for Increasing the Efficiency of Light Utilization and Luminance of a Display

(75) Inventors: Yaw-Jen Chang, Tao-Yuan (TW); Rong-Jhe Chen, Tao-Yuan (TW)

Correspondence Address: WPAT, PC, 7225 BEVERLY ST., ANNANDALE, VA, 22003, US

(73) Assignee: CHUNG YUAN CHRISTIAN UNIVERSITY, Tao-Yuan (TW)

(21) Appl. No.: 12/347,191

(22) Filed: Dec. 31, 2008

(30) Foreign Application Priority Data
Jan. 4, 2008 (TW) 097100523

(51) Int. Cl. G02F 1/1335; G02F 1/13357

(52) U.S. Cl. 349/62; 349/95

(57) ABSTRACT

The present invention discloses a structure for increasing the efficiency of light utilization and luminance of a display comprising a backlight unit and a display panel. In other words, a light collector is disposed between the backlight unit and the display panel for guiding light coming from an opaque area of the display to a transparent area of the display to increase the efficiency of light utilization and the luminance of the display, and the light is illuminated from the backlight unit to the opaque area of the display. Beside, the light collector can be formed by a microlens array.

### BACKGROUND OF THE INVENTION

1. Field of the Invention

The present invention relates to a structure of a display, particularly to a structure for increasing the efficiency of light utilization and luminance of a display comprising a backlight unit and a display panel.

2. Description of the Prior Art

The maturing market of liquid crystal displays (LCDs) pushes the manufacturing trend of LCD panels towards larger size and higher resolution. A (thin film transistor liquid crystal display) TFT-LCD has active matrix display grids with a transistor located at each dot (sub-pixel) intersection, known as thin-film transistor (TFT). As the resolution of TFT-LCDs gets higher, each pixel size becomes smaller. However, the dimensions of the TFTs, gate bus-line, data bus-line, and cs electrode remain unchanged. Then, the aperture ratio, defined as the effective area of a TFT pixel over its dimension, decreases. Therefore, there is a need to develop a novel structure for TFT-LCDs to resolve the issues mentioned above and increase the efficiency of light utilization.

### SUMMARY OF THE INVENTION

Therefore, in accordance with the previous summary, objects, features and advantages of the present disclosure will become apparent to one skilled in the art from the subsequent description and the appended claims taken in conjunction with the accompanying drawings.

An object of the present invention is to provide a light collector for TFT-LCDs. The light collector can be accomplished by a microlens array. By employing the character of the focusing of the lens, the light illuminates the opaque area, such as TFTs, data lines, and gates lines, and is guided to the transparent area to increase the lighting efficiency and the luminance, and also decrease the power consumption. Besides, according the result of the simulation, providing the microlens array for the TFT-LCD can increase 22.34% luminance that is equivalent to increase the aperture ratio.

### BRIEF DESCRIPTION OF THE DRAWINGS

The accompanying drawings incorporated in and forming a part of the specification illustrate several aspects of the present invention, and together with the description serve to explain the principles of the disclosure. In the drawings:

FIG. 1A is the structure of a TFT LCD built according to the first embodiment of the present invention;

FIG. 1B is the diagram of a pixel electrode plate corresponding to three microlenses built according to the first embodiment of the present invention;

FIG. 1C is the diagram of the LCD structure with a dual-convex lens built according to the first embodiment of the present invention;

FIG. 1D is the-plane-convex-lens LCD structure comprising a convex surface toward the backlight unit built according to the first embodiment of the present invention;

FIG. 1E is the diagram of a microlens array with the flattened convex surface built according to the first embodiment of the present invention;

FIG. 2A is a structure of a display comprising a backlight unit and a display panel for increasing the efficiency of light utilization and luminance built according to the second embodiment of the present invention, and the luminance-enhancement device is disposed between the backlight unit and the light collector;

FIG. 2B is the dual-convex lens array built according to the second embodiment of the present invention;

FIG. 2C is the plane-convex lens array with the convex surface toward the display panel built according to the second embodiment of the present invention;

FIG. 2D is the plane-convex lens array with the convex surface toward the backlight unit built according to the second embodiment of the present invention;

FIG. 2E is the microlens array with the flattened convex surface built according to the second embodiment of the present invention; and

FIG. 3 is the TFT LCD comprising a luminance-enhancement device built according to the third embodiment of the present invention.

### DETAILED DESCRIPTION OF THE PREFERRED EMBODIMENTS

The present disclosure can be described by the embodiments given below. It is understood, however, that the embodiments below are not necessarily limitations to the present disclosure, but are used to a typical implementation of the invention.

Having summarized various aspects of the present invention, reference will now be made in detail to the description of the invention as illustrated in the drawings. While the invention will be described in connection with these drawings, there is no intent to limit it to the embodiment or embodiments disclosed therein. On the contrary the intent is to cover all alternatives, modifications and equivalents included within the spirit and scope of the invention as defined by the appended claims.

It is noted that the drawings presents herein have been provided to illustrate certain features and aspects of embodiments of the invention. It will be appreciated from the description provided herein that a variety of alternative embodiments and implementations may be realized, consistent with the scope and spirit of the present invention.

It is also noted that the drawings presents herein are not consistent with the same scale. Some scales of some components are not proportional to the scales of other components in order to provide comprehensive descriptions and emphasizes to this present invention.

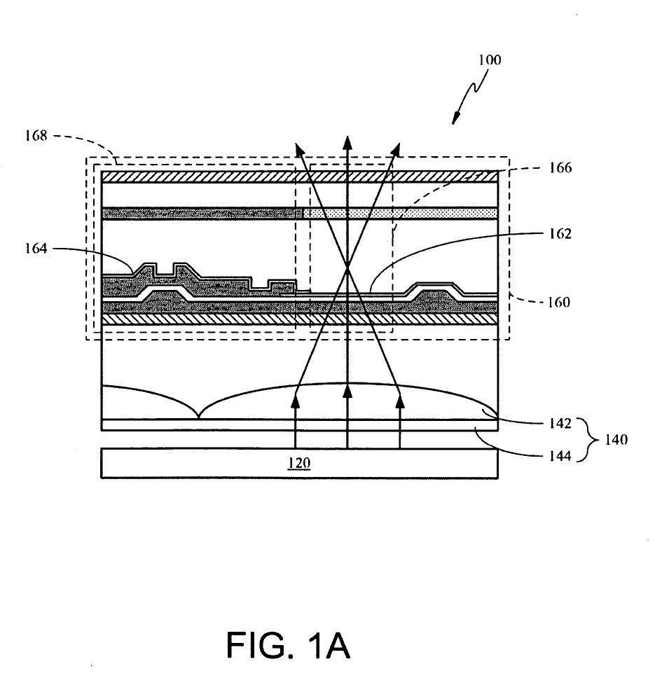

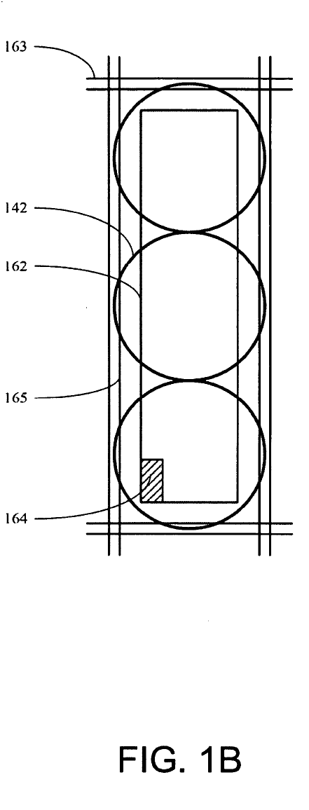

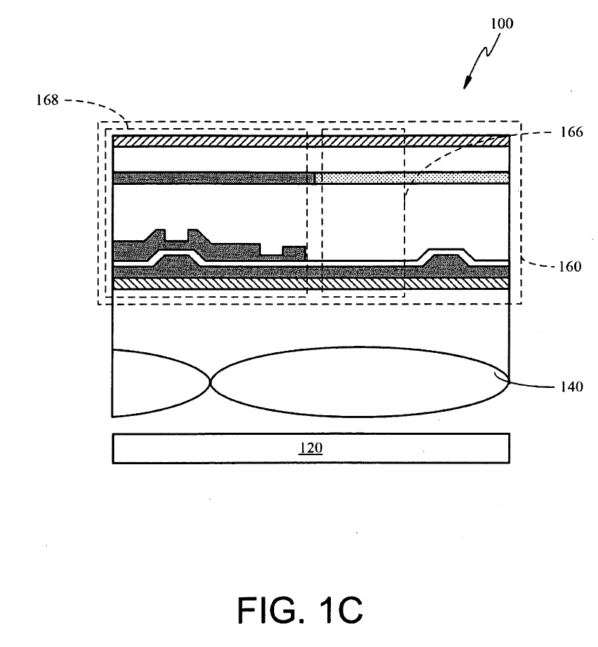

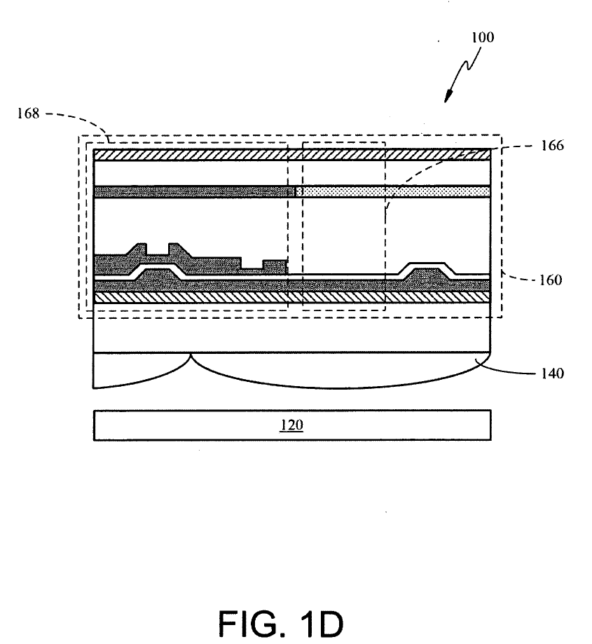

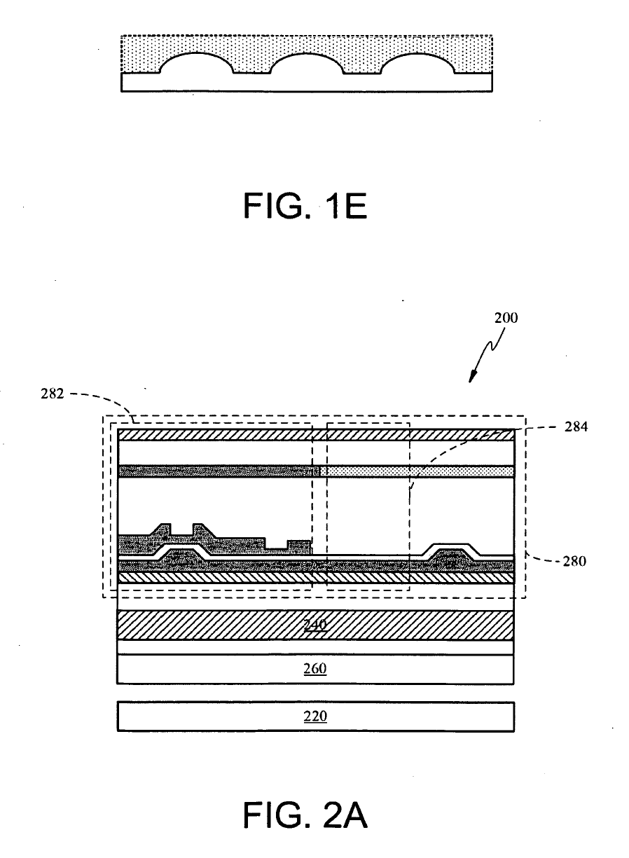

Referring to FIG. 1A, it is a TFT LCD 100, the first embodiment of the present invention, comprising a backlight unit 120, a microlens array 140, a display panel 160. The display panel 160 comprises a transparent area 166 and an opaque area 168. The microlens array 140 comprises a plurality of microlenses 142, and a substrate 144. The microlenses 142 are disposed on the substrate 144. The microlenses array 140 is disposed between the backlight unit 120 and the display panel 160 for focusing the light which illuminates the opaque area 168 and guiding the light to the transparent area 166. And the focused light is converted into an image by the display panel 160 to be output. The microlenses array 140 is connected with the display panel 160. The display panel 160 further comprises a plurality of pixel electrode plates 162, data lines 165, gate lines 163, and TFT 164. Every pixel electrode plate 162 corresponds to at least a microlens 142, Referring to FIG. 1B, it is a diagram to show that a pixel electrode plates corresponds to three microlenses. Besides, the areas corresponding to the microlens 142 also comprise one of the elements or their combination: data lines 165, gate lines 163, TFT 164. In the other side, the microlens array 140 can be manufactured in the micro-electro-mechanical system (MEMS) process, micro-injecting-molding process, wet etched mold transfer process, thermal reflow process, or formed from photosensitive glass. In an example, the type of the backlight unit 120 can be one of the following group: the direct type, side-edge type, LED backlight unit, and dual-surface type. The display panel 160 comprises the following components: the polarizer, glass substrate, transparent electrode plate, liquid crystal layer, color filter, TFT, and the other components known by the person skilled in the art. The backlight unit 120 comprises the following components: light-guiding plate, reflecting plate, diffusion plate, luminance-enhancement device, and the other components known by the person skilled in the art. In the other example, the microlens array 140 comprises a convex lens array, and the convex lens array can be a dual-convex lens array (as shown in FIG. 1C), a plane-convex lens array with the convex surface toward the display panel 160 (as shown in FIG. 1A) or the convex surface toward the backlight unit 120 (as shown in FIG. 1D). The microlens 142 is in a shape of an arc or cylinder. And the shape of contact edge between the convex surface and the substrate 144 or between two convex surfaces can be circle, triangle, parallelogram, or other polygons. Besides, the convex surface of the microlens can be flattened by fulfilling or thin film packaging (referring to FIG. 1E).

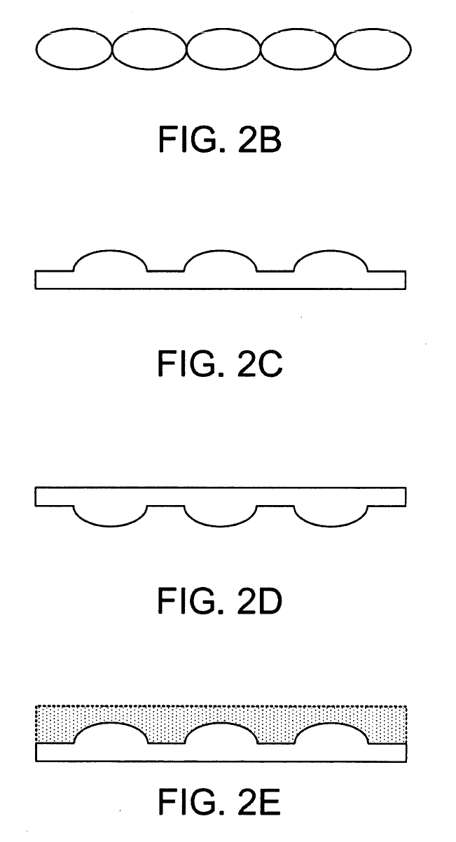

Referring to FIG. 2A, it is a structure for increasing the efficiency of light utilization and luminance of a display comprising a backlight unit 220 and a display panel 280, the second embodiment of the present invention. It comprises a light collector 240. The light collector 240 is disposed between the backlight unit 220 and the display panel 280 for guiding the light, coming to the backlight unit 220 and illuminating to the opaque area 282 of the display panel, to the transparent area 284 of the display panel 280. Accordingly, it can increase the lighting-efficiency and the luminance of the display. The light collector 240 is connected with the display panel 280. The display further comprises a luminance-enhancement device 260. The luminance-enhancement device can be a brightness enhancement film (BEF). The luminance-enhancement device 260 is disposed between the backlight unit 220 and the light collector 240 (as shown in FIG. 2A), and the light collector is connected with the display panel 280. In an embodiment, the light collector 240 can be a microlens array. The microlens array comprises a plurality of microlenses and a substrate, and the microlenses are disposed on the substrate. In an embodiment, the light collector 240 can be a microlens array, and the microlens array comprises a plurality of microlenses and a substrate. The microlenses are disposed on the substrate, The microlens array can be a convex lens array, and the convex lens array can be a dual-convex lens array (as shown in FIG. 2B), a plane-convex lens array with the convex surface toward the display panel 160 (as shown in FIG. 2C) or the convex surface toward the backlight unit 120 (as shown in FIG. 2D). The microlens 142 is in a shape of an arc or cylinder. And the shape of contact edge between the convex surface and the substrate 144 or two convex surfaces can be circle, triangle, parallelogram, or other polygons. Besides, the convex surface of the microlens can be flattened by fulfilling or thin film packaging (referring to FIG. 2E).

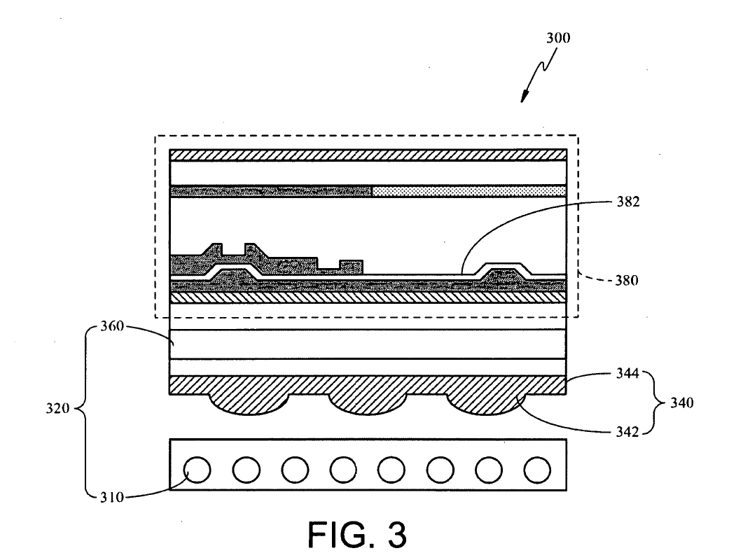

Referring to FIG. 3, it is an LCD 300, the third embodiment of the present invention. It comprises a backlight unit 320, which comprises a luminance-enhancement device 360 and a light source 310, a microlens array 340, which comprises a plurality of microlenses 342 and a substrate 344, and a display panel 380. The luminance-enhancement device 360 is disposed between the display panel 380 and the microlens array 340, the microlens array 340 is disposed between the luminance-enhancement device 360 and the light source 310, and the microlens 342 is disposed on the substrate 344. The light coming from the light source 310 is focused by the microlens 342, and the processed by the luminance-enhancement device 360 for increasing the directivity of the light from the light source 310, and finally focused on the display panel 380 and converted into an image by the display panel 380 to be output. The luminance-enhancement device 360 can be a BEF. Besides, the display panel 380 further comprises a plurality of pixel electrode plates 382, and every pixel electrode plate 382 corresponds to at least a microlens 342. In the other side, the microlens array 340 can be manufactured in the micro-electro-mechanical system (MEMS) process, micro-injecting-molding process, wet etched mold transfer process, thermal reflow process, or formed from photosensitive glass. In an example, the type of the backlight unit 320 can be one of the following groups: the direct type, side-edge type, LED backlight unit, and dual-surface type. The display panel 380 comprises the following components: the polarizer, glass substrate, transparent electrode plate, liquid crystal layer, color filter, TFT, and the other components known by the person skilled in the art. The backlight unit 320 comprises the following components: light-guiding plate, reflecting plate, diffusion plate, luminance-enhancement device, and the other components known by the person skilled in the art. In the other example, the microlens array 340 comprises a convex lens array, and the convex lens array can be a dual-convex lens array, a plane-convex lens array with the convex surface toward the luminance-enhancement device 360 or the convex surface toward the light source 310. The microlens 342 is in a shape of an arc or cylinder. And the shape of contact edge between the convex surface and the substrate 344 or between two convex surfaces can be circle, triangle, parallelogram, or other polygons. Besides, the convex surface of the microlens 340 can be flattened by fulfilling or thin film packaging.

The fourth embodiment of the present invention discloses a method for increasing the efficiency of light utilization and luminance of a display. At first a backlight unit and a display panel are provided, and a light collector is disposed between the backlight unit and the display panel. The display panel comprises a transparent area and an opaque area. The light collector guides the light, which comes to the backlight unit and illuminating to the opaque area of the display panel, to the transparent area of display panel. Accordingly, it can increase the lighting-efficiency and the luminance of the display. The light collector is connected with the display panel, and the light collector can be a microlens array. The microlens array comprises a plurality of microlenses and a substrate. The microlens is disposed on the substrate. Besides, the microlens array can be a convex lens array, and the convex lens array can be a dual-convex lens array, a plane-convex lens array with the convex surface toward the display panel or the convex surface toward the backlight unit. The microlens is in a shape of an arc or cylinder. And the shape of contact edge between the convex surface and the substrate or between two convex surfaces can be circle, triangle, parallelogram, or other polygons. The display further comprises a luminance-enhancement device. The luminance-enhancement device 360 can be a BEF. The luminance-enhancement device is disposed between the backlight unit and the display panel. In the other side, the microlens array can be manufactured in the MEMS process, micro-injecting-molding process, wet etched mold transfer process, thermal reflow process, or formed from photosensitive glass. In an example, the type of the backlight unit can be one of the following groups: the direct type, side-edge type, LED backlight unit, and dual-surface type. The display panel comprises the following components: the polarizer, glass substrate, transparent electrode plate, liquid crystal layer, color filter, TFT, and the other components known by the person skilled in the art. The backlight unit 320 comprises the following components: light-guiding plate, reflecting plate, diffusion plate, LUMINANCE-ENHANCEMENT DEVICE, and the other components known by the person skilled in the art. In the other example, the microlens array comprises a convex lens array, and the convex lens array can be a dual-onvex lens array, a plane-convex lens array with the convex surface toward the luminance-enhancement device or the convex surface toward the light source 310. The microlens is in a shape of an arc or cylinder. And the shape of contact edge between the convex surface and the substrate or between two convex surfaces can be circle, triangle, parallelogram, or other polygons. Besides, the convex surface of the microlens can be flattened by fulfilling or thin film packaging.

The foregoing description is not intended to be exhaustive or to limit the invention to the precise forms disclosed. Obvious modifications or variations are possible in light of the above teachings. In this regard, the embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the inventions as determined by the appended claims when interpreted in accordance with the breath to which they are fairly and legally entitled.

It is understood that several modifications, changes, and substitutions are intended in the foregoing disclosure and in some instances some features of the invention will be employed without a corresponding use of other features. Accordingly, it is appropriate that the appended claims be construed broadly and in a manner consistent with the scope of the invention.

1. A structure for increasing the efficiency of light utilization and luminance of a display comprising a backlight unit and a display panel, comprising:
a light collector, disposed between the backlight unit and the display panel of the display for guiding light coming from an opaque area of the display to a transparent area of the display to increase the lighting efficiency and the luminance of the display, wherein the light is illuminated from the backlight unit to the opaque area of the display.

2. The structure for increasing the efficiency of light utilization and the luminance of a display comprising a backlight unit and a display panel according to claim 1, wherein the light collector comprises a microlens array and the microlens array comprises a convex lens array, a plane-convex lens array with a convex surface toward the backlight unit, a plane-convex lens array with a convex surface toward the display panel, or a dual-convex lens array.

3. The structure for increasing the efficiency of light utilization and the luminance of a display comprising a backlight unit and a display panel according to claim 2, wherein the microlens array is an arc or a cylinder, and a shape of contact edge between two microlenses of the microlens array are circle, triangle, parallelogram, or other polygons.

4. The structure for increasing the efficiency of light utilization and the luminance of a display comprising a backlight unit and a display panel according to claim 1, wherein the light collector is connected with the display panel.

5. The structure for increasing the efficiency of light utilization and the luminance of a display comprising a backlight unit and a display panel according to claim 2, wherein the display further comprises a luminance-enhancement device and the luminance-enhancement device is disposed between the backlight unit and the light collector, or between the light collector and the display panel.

6. A liquid crystal display, comprising:
a backlight unit;
a display panel, comprising a transparent area and an opaque area;
a microlens array, comprising a plurality of microlenses disposed between the backlight unit and the display panel, wherein the microlens array is used for collecting light coming from the opaque area, guides the light to the transparent area, and the light coming from the transparent area is converted into an image by the display to be output, wherein the light is illuminated by the backlight unit.

7. The liquid crystal display according to claim 6, wherein the display panel further comprises a plurality of pixel electrode plates, and the pixel electrode plates correspond to at least a microlens.

8. The liquid crystal display according to claim 6, wherein the microlens array comprises the microlens array comprises a convex lens array, a plane-convex lens array with a convex surface toward the backlight unit, a plane-convex lens array with a convex surface toward the display panel, or a dual-convex lens array.

9. The liquid crystal display according to claim 6, wherein the microlens array is an arc or a cylinder, and a shape of contact edge between two microlenses of the microlens array are circle, triangle, parallelogram, or other polygons.

10. The liquid crystal display according to claim 6, wherein the microlens array is formed in a micro-electro-mechanical system (MEMS) process, micro-injecting-molding process, wet etched mold transfer process, thermal reflow process, exposing photosensitive glass, or a combination thereof.

11. A liquid crystal display, comprising:
a backlight unit, comprising a light source and a luminance-enhancement device, wherein the luminance-enhancement device is used for increasing the directivity of the light from the light source;
a microlens array, comprising a plurality of microlenses, wherein the microlens array is disposed between the light source and the luminance-enhancement device for collecting light coming from the light source;
a display panel disposed above the luminance-enhancement device, wherein the light coming from the light source is collected by the microlenses, processed by the luminance-enhancement to be focused on the display panel, and converted into an image by the display panel to be output.

12. The liquid crystal display according to claim 11, wherein the display panel further comprises a plurality of pixel electrode plates, and the pixel electrode plates corresponds to at least a microlens.

13. The liquid crystal display according to claim 11, wherein the microlens array comprises a convex lens array, a plane-convex lens array with a convex surface toward the backlight unit, a plane-convex lens array with a convex surface toward the display panel, or a dual-convex lens array.

14. The liquid crystal display according to claim 11, wherein the microlens array is an arc or a cylinder, and a shape of contact edge between two microlenses of the microlens array are circle, triangle, parallelogram, or other polygons.

15. The liquid crystal display according to claim 11, wherein the microlens array is formed in a MEMS process, micro-injecting-molding process, wet etched mold transfer process, thermal reflow process, exposing photosensitive glass or a combination thereof.

16. A method for increasing the efficiency of light utilization and luminance of a display, comprising:
providing a backlight unit and a display panel, wherein the display panel comprises a transparent area and an opaque area;
placing a light collector between the backlight unit and the display panel, wherein the light collector guides light coming from an opaque area of the display to a transparent area of the display to increase the efficiency of light utilization and the luminance of the display, wherein the light is illuminated from the backlight unit to the opaque area of the display.

17. The method for increasing the efficiency of light utilization and luminance of a display according to claim 16, wherein the light collector comprises a microlens array.

18. The method for increasing the efficiency of light utilization and luminance of a display according to claim 17, further comprising a MEMS process, micro-injecting-molding process, wet etched mold transfer process, thermal reflow process, exposing photosensitive glass, or a combination thereof to form the microlens array.

19. The method for increasing the efficiency of light utilization and luminance of a display according to claim 16, wherein the light collector is connected with the display panel.

20. The method for increasing the efficiency of light utilization and luminance of a display according to claim 16, further comprising providing a luminance-enhancement device between the backlight unit and the light collector, or between the light collector and the display panel.
